(19) United States
(12) Patent Application Publication
(10) Pub. No.: US 2010/0209183 A1
(43) Pub. Date: Aug. 19, 2010

(54) MECHANICAL LOCKING ARRANGEMENT OF AN AXIAL DISK

(75) Inventors: Wolfgang Fugel, Nuernberg (DE); Alexander Reimchen, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/668,678

(22) PCT Filed: Jun. 6, 2008
(86) PCT No.: PCT/EP2008/057101

§ 371 Date: Feb. 9, 2010

(30) Foreign Application Priority Data
Jul. 13, 2007 (DE) 10 2007 032 655.8

(51) Int. Cl. F16B 7/04

(52) U.S. Cl. 403/252

(57) ABSTRACT

The invention relates to a mechanical locking arrangement of an axial disk (7, 14) which is connected to a housing (1) or to a shaft (15), wherein the housing (1) has a receiving opening (3) into which the axial disk (7) is inserted, or the shaft (15) is surrounded by a central receiving bore (16) of the axial disk (14). According to the invention, an elastically flexible connecting element (6) is arranged between an inner lateral surface of the receiving opening (3) of the housing (1) and an outer lateral surface of the axial disk (7), or between the central receiving bore (16) of the axial disk (14) and the shaft (15), which connecting element (6) has a shape which deviates from that of a circle, and which connecting element (6) connects the housing (1) and the axial disk (7) or the shaft (15) and the axial disk (14) to one another in a force-fitting manner, wherein the connecting element (6), at a plurality of points which are spaced apart from one another in the peripheral direction, makes contact under preload with the receiving opening (3) and axial disk (7) or shaft (15) and axial disk (14).

### FIELD OF THE INVENTION

The invention relates to the mechanical locking arrangement of an axial disk, which is connected to a housing or to a shaft, the housing having a receiving opening into which the axial disk is inserted, or the shaft being surrounded by a central receiving bore of the axial disk.

### BACKGROUND OF THE INVENTION

Axial disks of this kind are used as thrust washers or, in the construction of transmissions, as housing or shaft disks, for example, in the latter case serving as races for rolling elements. According to the existing prior art, axial disks of this kind are manufactured as shims, which must be produced by an expensive machining process in order to ensure narrow tolerances between the axial disk and the adjoining structure associated with it. These narrow tolerances are required because there has to be a slight overlap between the axial disk and a receiving bore in order to enable the axial disk to be snapped into the receiving bore. In this case, it has proven advantageous if the axial disk is provided with a chamfer on its radially outer end. This means that the diameter and the outer lateral surface of the axial disk must meet the highest possible requirements as regards dimensional accuracy and smoothness. As a consequence, however, disks of this kind have to be brought to the required dimensional precision in an expensive manner by sawing, turning and grinding. Stamped disks, which are significantly simpler and hence cheaper to manufacture, are not suitable for this purpose since their lateral surface has what are referred to as punch breakouts, i.e. does not have the required smooth surface. Another disadvantage is that the fastening of an axial disk of this kind to an adjoining structure is not sufficiently secure, i.e. when it is a matter of “overhead installation” the axial disk may become disengaged from its adjoining structure owing to gravity.

### SUMMARY OF THE INVENTION

Taking as its starting point the disadvantages of the known prior art, the underlying object of the invention is therefore to develop a locking arrangement for an axial disk, which acts by nonpositive engagement in an axial direction and significantly reduces the overall effort required for the fastening thereof.

According to the invention, this object is achieved by the characterizing part of claim 1 in conjunction with the preamble thereof in that an elastically flexible connecting element is arranged between an inner lateral surface of the receiving opening of the housing and an outer lateral surface of the axial disk, or between the central receiving bore of the axial disk and the shaft, which connecting element has a shape which deviates from that of a circle, and which connecting element connects the housing and the axial disk or the shaft and the axial disk to one another by nonpositive engagement, the connecting element making contact under preload with the receiving opening and the axial disk or the shaft and the axial disk at a plurality of points which are spaced apart from one another in a circumferential direction.

The decisive advantage of the solution according to the invention is that, thanks to the use of the elastic connecting element, there is no need for particularly stringent requirements on the axial disk used. In particular, it is not necessary to maintain narrow tolerances between the adjoining structure and the axial disk. This applies both to the diameter of the axial disk and to the roughness of its lateral surface. By virtue of the fact that its shape deviates from that of a circle, the elastic connecting element largely compensates for tolerances and any play between the axial disk and the adjoining structure in a simple manner. In particular, it is possible to use stamped axial disks, the production of which involves significant advantages, since they do not have to be ground in an expensive manner. Another advantage of the mechanical locking arrangement according to the invention is that it works reliably. Thus, particularly in the case of “overhead installation”, it is not possible for the axial disk and the adjoining structure to separate under the influence of gravity. Making the connecting element polygonal in such a way that there is an arched portion at each of three uniformly spaced points on the circumference ensures that reliable retention of the axial disk and the adjoining structure is achieved under all operating conditions. The angular design of the connecting element ensures, on the one hand, that it has increased strength and, on the other hand, that there is improved contact by the angled axial disk. Depending on whether the axial disk is used as a shaft disk or as a housing disk, the arched portions of the elastic connecting element are arranged radially on the outside or radially on the inside. It has also proven advantageous if the connecting element is composed of a ferrous material which is, on the one hand, embodied in a very thin-walled manner and, on the other hand, has sufficiently high elasticity.

Further features of the invention will emerge from the following description and from the drawings, in which two exemplary embodiments of the invention are shown in simplified form.

### BRIEF DESCRIPTION OF THE DRAWINGS

In the drawings:

FIG. 1 shows a perspective view of a housing disk before installation in an adjoining structure;

FIG. 2 shows a plan view of the arrangement in FIG. 1 after installation has taken place;

FIG. 3 shows a plan view of a first variant of a connecting element designed in accordance with the invention;

FIG. 4 shows a plan view of the connecting element in FIG. 3 with the axial disk inserted;

FIG. 5 shows a perspective view of the arrangement in FIG. 4 before insertion of the axial disk;

FIG. 6 shows an axial section through an axial disk before the connecting element is in contact;

FIG. 7 shows the same axial section as that in FIG. 6 with the connecting element placed on;

FIG. 8 shows a plan view of a further adjoining structure;

FIG. 9 shows a plan view of a second variant of the connecting element according to the invention;

FIG. 10 shows a perspective view of the connecting element in FIG. 9;

FIG. 11 shows an axial section through an axial disk with the second connecting element in accordance with FIG. 9; and

FIG. 12 shows the same axial section with the connecting element fitted.

### DETAILED DESCRIPTION OF THE DRAWINGS

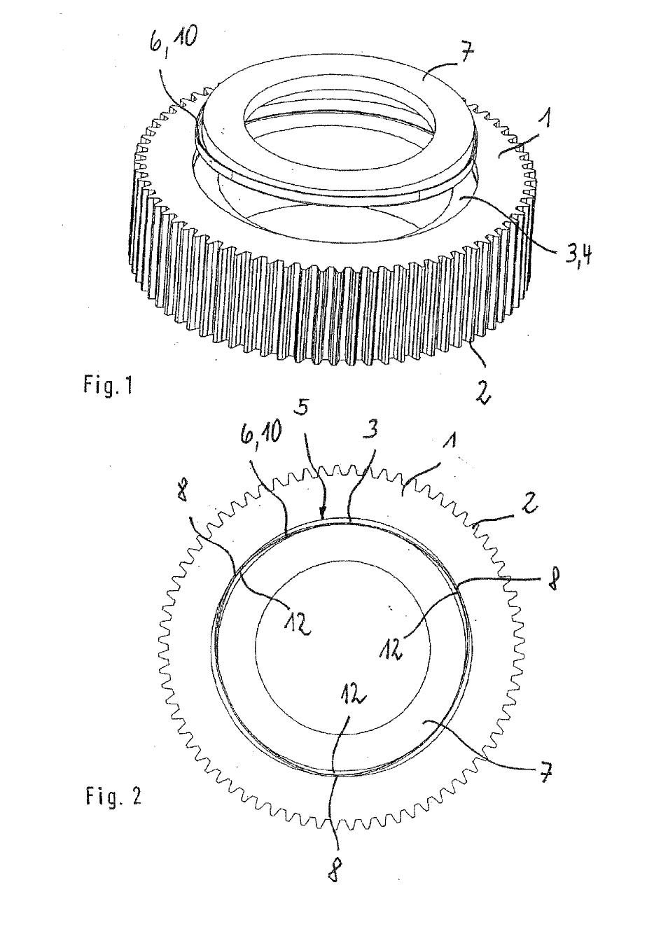

FIGS. 1 and 2 show an adjoining structure in the form of a sun gear 1, which is part of every planetary gearset. Planetary gearsets of this kind are the heart of every automatic transmission. A plurality of planet gears spaced uniformly apart in a circumferential direction, the teeth of which engage in the circumferential toothing 2 of the sun gear 1, are arranged around the sun gear 1 in a manner not shown. The planet gears, in turn, are surrounded by an annulus, likewise not shown, the internal toothing of which meshes with the toothing of the planet gears. As can furthermore be seen, the sun gear 1 is provided with a circular receiving opening 3, which is delimited in an axial direction by the shoulder 4 and in a radial direction by the lateral surface 5.

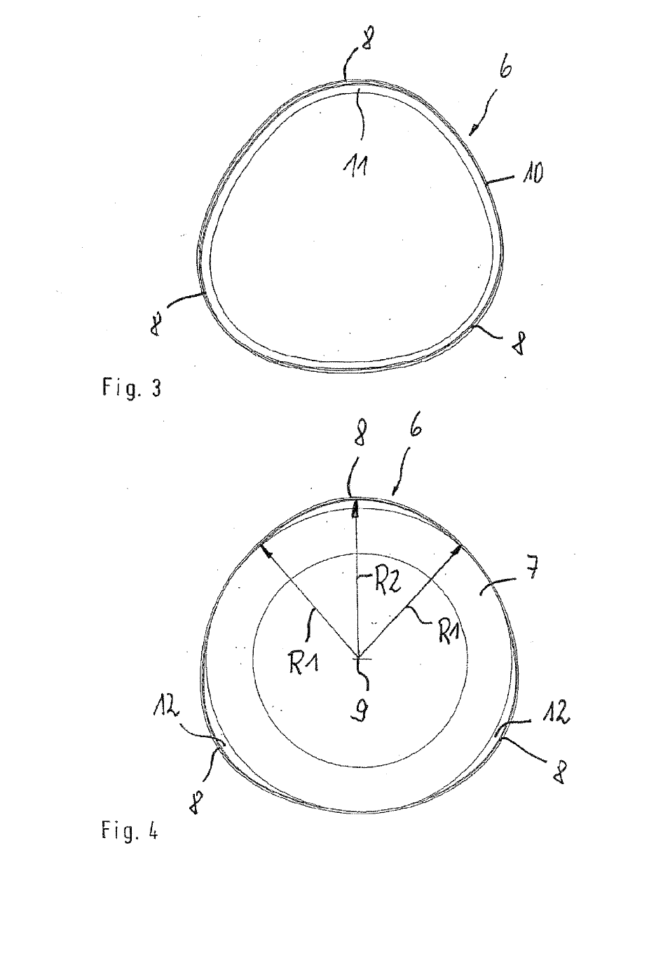

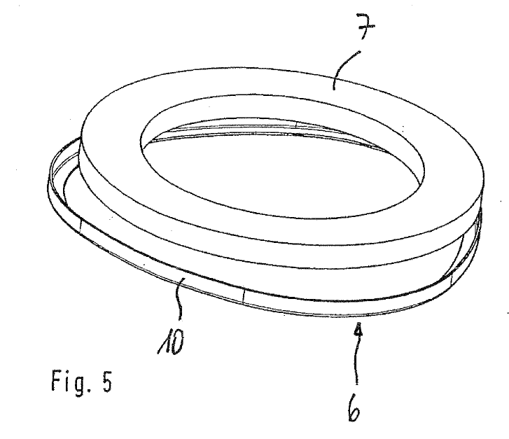

As FIGS. 1 and 2 furthermore show, a connecting element 6 is inserted into the receiving opening 3 in the sun gear 1, and this connecting element in turn receives the axial disk 7. As FIGS. 3, 4 and 5, in particular, show, the connecting element 6 has a shape which deviates from that of a circle, As can be seen from FIGS. 3 and 4, the connecting element 6 is designed substantially as a polygon, i.e. a many-angled figure, in the exemplary embodiment as a triangle which has arched portions 8 at three points on the circumference spaced apart uniformly in a circumferential direction, said arched portions having, in relation to a common axis 9, the maximum radius R2, which lies at the apex of the arched portion 8. This maximum radius R2 of the arched portion 8 decreases on both sides in a circumferential direction until finally, at the beginning and end of the arched portion 8, the radius R2 is equal to the radius R1, which corresponds to the radius of the enclosed axial disk 7. As a result, the axial disk 7 is enclosed on all sides by the connecting element 6 except for the arched portions 8. The connecting element 6 is of angular design, the radially extending part 11 merging into the axially extending part 10, which reaches partially around the lateral surface of the axial disk 7. As FIG. 4 furthermore shows, there is a maximum overlap, designated by 12, at the apex of the arched portion 8, and the amount of this overlap can be up to one millimeter, depending on the application.

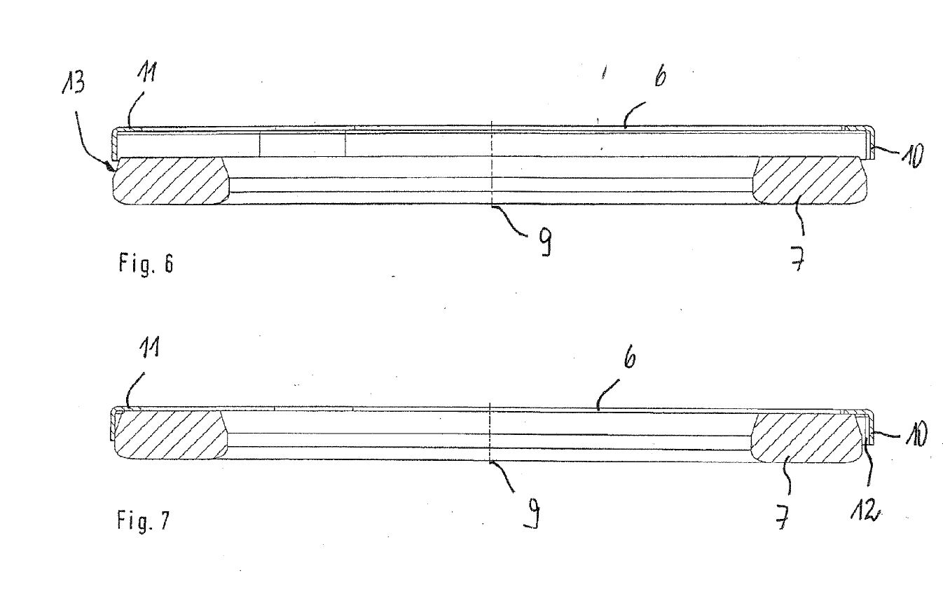

Referring to FIG. 2, it can be seen that the axial disk 7 is, on the one hand, accommodated in the receiving opening 3 in the sun gear 1 over a large part of its circumference by the axially extending part 11 of the connecting element 6. Only in the region of the arched portions 8 there is no contact between the axial disk 7 and part 10 of the connecting element 6. On the other hand, the axial disk 7 is held in the receiving opening 3 by means of the arched portions 8 of the connecting element 6, the arched portions 8 resting against the lateral surface 5 of the receiving opening 3. It can also be seen from FIG. 2 that, owing to the fact that the shape of the connecting element 6 deviates from that of a circle, said connecting element simultaneously makes contact with the lateral surface of the axial disk 7 and the lateral surface 5 of the receiving opening 3, with the result that the axial disk 7 is connected by nonpositive engagement to the sun gear 1. FIGS. 6 and 7, which show a stamped axial disk 7 before and after it is snap-fitted with the elastic connecting element 6, show the oblique punch breakout 13 on the axial disk 7. This serves as an introduction surface for the axially extending part 10 of the connecting element 6, allowing said connecting element and the axial disk 7 to be snapped together in a simple manner.

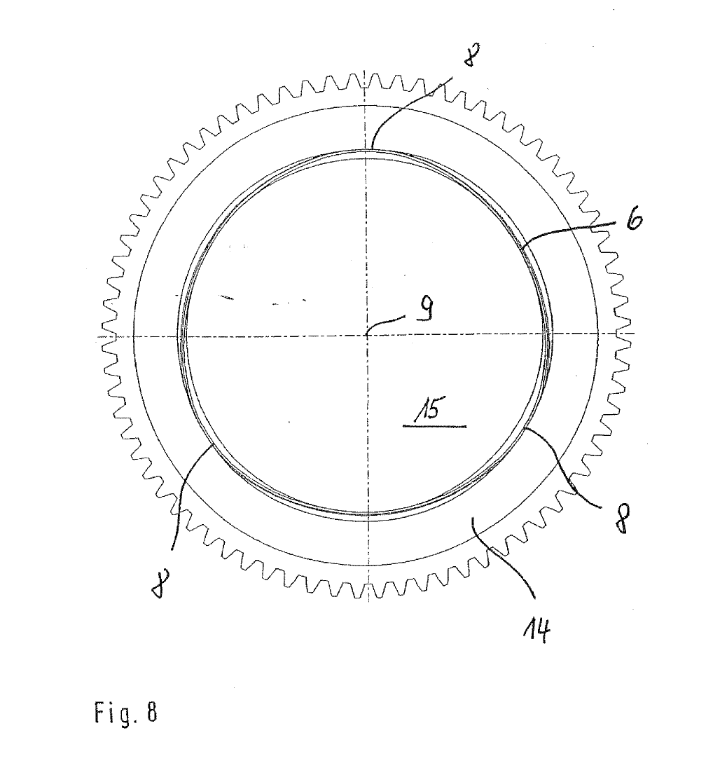

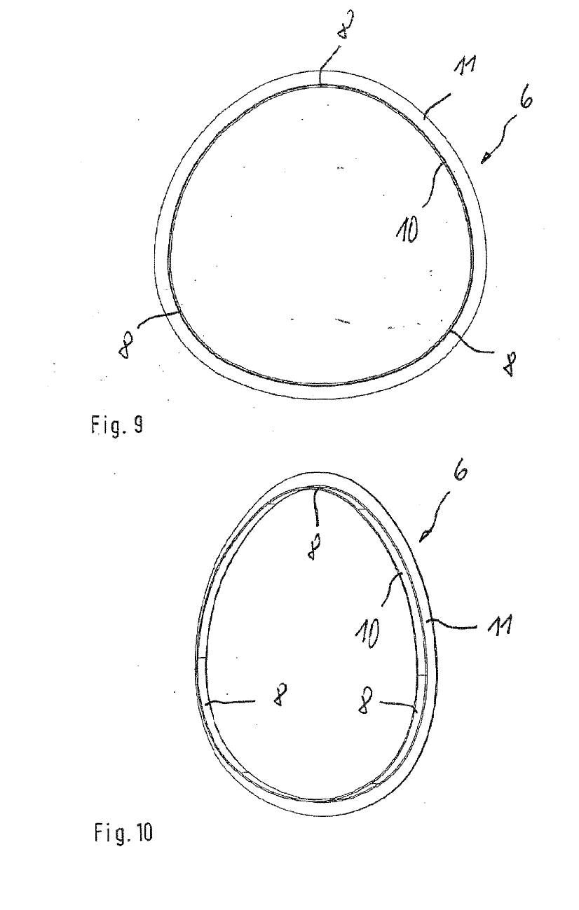

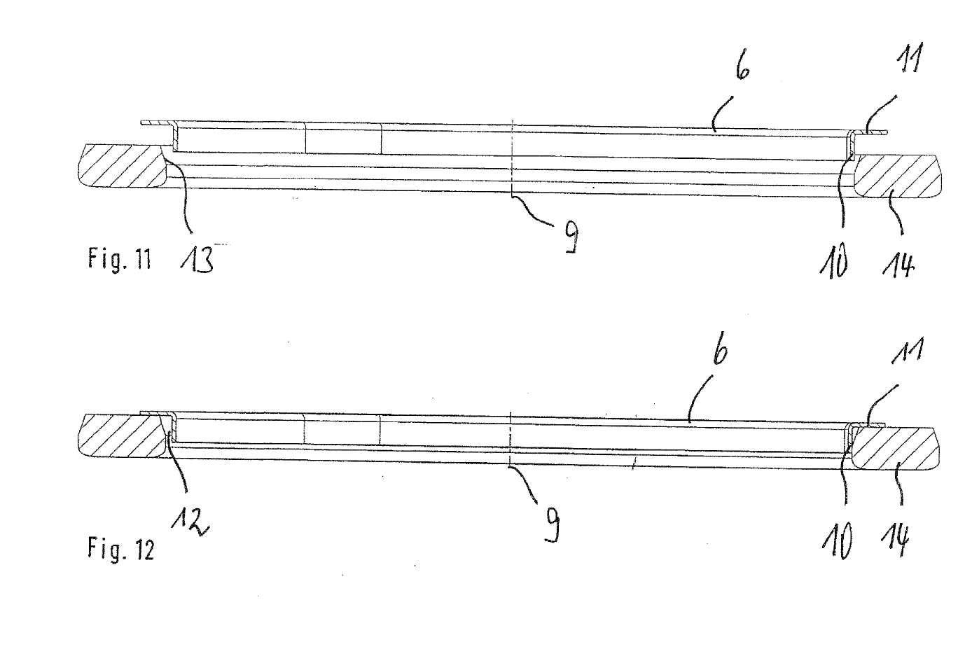

In contrast to the exemplary embodiment described above, that shown in FIGS. 8 to 12 is distinguished essentially in that the axial disk, which is designated by 14, is not connected by nonpositive engagement to a housing but to the shaft 15. As can be seen, the connecting element 6 is inserted into the receiving bore 16 in the axial disk 14 and rests by way of its arched portions 8 at three points on the circumference against the inner lateral surface of the receiving bore 16. The shaft 15 in turn, which is surrounded concentrically by the connecting element 6, is in turn firmly enclosed by the axially extending part 10 of the connecting element 6, except for the arched portions 8. In this way, the axial disk 14 is connected firmly to the shaft 15 by the connecting element 6, and in this case the axial disk 14 is to be referred to as a shaft disk. However, the connecting element 6 must be designed in such a way that its axially extending part 10 is arranged not on the outer radial end but on the inner radial end because this part 10 must engage in the receiving bore 16 in the axial disk 14. Otherwise, the same features and modes of operation of the first exemplary embodiment that have already been described above apply, and a repeated detailed description at this point may therefore be dispensed with.

### REFERENCES

1 Sun gear
2 Toothing
3 Receiving opening
4 Shoulder
5 Lateral surface
6 Connecting element
7 Axial disk
8 Arched portion
9 Axis
10 Axially extending part
11 Radially extending part
12 Overlap
13 Punch breakout
14 Axial disk
15 Shaft
16 Receiving bore
R1 Radius
R2 Radius

1. A mechanical locking arrangement of an axial disk, which is connected to a housing or to a shaft, the housing having a receiving opening into which the axial disk is inserted, or the shaft being surrounded by a central receiving bore of the axial disk,
wherein an elastically flexible connecting element is arranged between an inner lateral surface of the receiving opening of the housing and an outer lateral surface of the axial disk, or between the central receiving bore of the axial disk and the shaft, the connecting element has a shape which deviates from that of a circle, and that connects the housing and the axial disk or the shaft and the axial disk to one another by nonpositive engagement, the connecting element making contact under preload with the receiving opening and the axial disk or the shaft and the axial disk at a plurality of points which are spaced apart from one another in a circumferential direction.

2. The mechanical locking arrangement of claim 1, wherein the non-positive engagement is designed in such a way that a retention force of the non-positive engagement prevents detachment of the housing and the axial disk or of the shaft and the axial disk due to gravity.

3. The mechanical locking arrangement of claim 1, wherein the connecting element is designed to be polygonal in such a way that there is an arched portion at each of three uniformly spaced points on the circumference.

4. The mechanical locking arrangement of claim 1, wherein the connecting element is of angular design.

5. The mechanical locking arrangement of claim 4, wherein each arched portion of the elastic connecting element is arranged so as to be radially on an outside or radially on an inside.

6. The mechanical locking arrangement of claim 1, wherein the connecting element is composed of a ferrous material.

7. The mechanical locking arrangement of claim 1, wherein the axial disk is produced as a stamped component.
